(19) United States
(12) Patent Application Publication
(10) Pub. No.: US 2024/0076458 A1
(43) Pub. Date: Mar. 7, 2024

(54) RHEOLOGY MODIFIED OLEFIN-BASED POLYMER COMPOSITIONS

(71) Applicant: Dow Global Technologies LLC, Midland, MI (US)

(72) Inventors: Jeffrey C. Munro, Bellaire, TX (US); Santosh S. Bawiskar, Sugar Land, TX (US); Colin Li Pi Shan, Pearland, TX (US); Alexander Williamson, Rosharon, TX (US); Teresa P. Karjala, Lake Jackson, TX (US)

(21) Appl. No.: 18/549,098

(22) PCT Filed: May 11, 2022
(86) PCT No.: PCT/US2022/028687

§ 371 Date: Sep. 5, 2023

Related U.S. Application Data
(60) Provisional application No. 63/187,860, filed on May 12, 2021.

(51) Int. Cl. C08J 3/24; C08J 3/28

(52) U.S. Cl. CPC C08J 3/247; C08J 3/28; C08J 2323/08; C08J 2323/22

(57) ABSTRACT

A process to form a rheology modified composition, the process comprising applying radiation, and optionally heat, to a composition that comprises at least the following component: a) an olefin-based polymer comprising a total unsaturation ≥0.20 /1000 C; and wherein the radiation is applied using an electron beam (e-beam) at a dosage selected from 0.1 MRad to 1.5 MRad; and wherein component a is selected from a telechelic polyolefin of the formula A¹L¹L²A², an unsaturated polyolefin of the formula A¹L¹, or an ethylene/alpha-olefin interpolymer. A process to form a rheology modified composition, the process comprising applying heat, and optionally radiation, to a composition that comprises at least the following components: a) an olefin-based polymer, as described above, comprising a total unsaturation ≥0.20/1000 C; b) from 1.0 to 100 ppm of a peroxide, based on the weight of the composition.

### REFERENCE TO RELATED APPLICATIONS

This application claims the benefit of priority to U.S. Provisional Application No. 63/187,860, filed on May 12, 2021.

### BACKGROUND OF THE INVENTION

Shear thinning rheology, especially low viscosity at the higher shear rates, typical in extrusion and other processing operations, is desired for improved processability of olefin-based polymers. A significant degree of shear thinning at high temperatures is important for manufacturing methods, such as extrusion, injection molding, cast film, calendared film, and blown film Typical olefin-based polymers, such as LLDPE (linear low density polyethylene) or substantially linear ethylene polymers, have low levels of long chain branching, and typically do not have high shear thinning rheology. These olefin-based polymers are relatively insensitive to rheology modification methods. There is a need for rheology modified polymer compositions, and methods for forming the same, with high shear thinning rheology.

International Publication WO2020/140067 discloses a curable composition comprising a telechelic polyolefin of the formula A¹L¹L²A² or an unsaturated polyolefin of the formula A¹L¹. This reference discloses, in general, that its curable formulations, further comprising a cross-linking agent, may be rheology modified by curing via e-beaming (see paragraph [0255]). See also WO2020/135708A1, WO2020/140058, WO2020/140061 and WO2020/135680.

U.S. Pat. No. 6,689,851 discloses a rheology-modified ethylene polymer having less than 0.5 weight percent gel, a composition distribution breadth index (CDBI) greater than 50 percent, and a molecular weight distribution of less than 4.0, and which is characterized as having improved rheological performance and/or melt strength relative to the unmodified polymer (see abstract). Other curable polymers with unsaturation are disclosed in European Application EP2958151A1 and JP2012009688A (machine translation). Modified polymers are disclosed in WO2019/067239, WO2020/263681 and U.S. Pat. No. 10,844,210.

However, as discussed, there remains a need for rheology modified polymer compositions, and methods for forming the same, with high shear thinning rheology. This need has been met by the following invention.

### SUMMARY OF THE INVENTION

In a first aspect, a process to form a rheology modified composition, the process comprising applying radiation, and optionally heat, to a composition that comprises at least the following component:
a) an olefin-based polymer comprising a total unsaturation ≥0.20/1000 C; and wherein the radiation is applied using an electron beam (e-beam) at a dosage selected from 0.1 MRad to 1.5 MRad; and
wherein component a is selected from a telechelic polyolefin of the formula A¹L¹L²A², an unsaturated polyolefin of the formula A¹L¹, or an ethylene/alpha-olefin interpolymer.

In a second aspect, a process to form a rheology modified composition, the process comprising applying heat, and optionally radiation, to a composition that comprises at least the following components:
a) an olefin-based polymer comprising a total unsaturation ≥0.20/1000 C;
b) from 1.0 to 100 ppm of a peroxide, based on the weight of the composition; and
wherein component a is selected from a telechelic polyolefin of the formula A¹L¹L²A², an unsaturated polyolefin of the formula A¹L¹, or an ethylene/alpha-olefin interpolymer.

In a third aspect, a rheology modified composition formed from one of the above processes.

In a fourth aspect, a rheology modified composition comprising the following properties:
i) a V0.1 (at 190° C.) ≥20 Pa·s, and
ii) a rheology ratio (RR=V0.1/V100, each at 190° C.) ≥1.1; and
wherein the rheology modified composition is formed from a composition comprising an olefin-based polymer comprising a total unsaturation ≥0.20/1000 C; and
wherein the olefin-based polymer is selected from a telechelic polyolefin of the formula A¹L¹L²A², an unsaturated polyolefin of the formula A¹L¹, or an ethylene/alpha-olefin interpolymer.

In a fifth aspect, a composition comprising at least the following components:
a) an olefin-based polymer comprising a total unsaturation ≥0.20/1000 C;
b) from 1.0 to 100 ppm of a peroxide, based on the total weight of the composition; and wherein component a is selected from a telechelic polyolefin of the formula A¹L¹L²A², an unsaturated polyolefin of the formula A¹L¹, or an ethylene/alpha-olefin interpolymer.

### DETAILED DRESCRIPTION OF THE INVENTION

Rheology modified olefin-based polymer compositions, and methods to form the same, have been discovered, which have improved sensitivity to e-beam radiation and peroxide, and show higher levels of shear thinning and melt strength compared to conventional olefin-based polymer compositions.

As discussed above, in a first aspect, a process to form a rheology modified composition, the process comprising applying radiation, and optionally heat, to a composition as discussed above. In a second aspect, a process to form a rheology modified composition, the process comprising applying heat, and optionally radiation, to a composition as discussed above. In a third aspect, a rheology modified composition formed from an inventive process. In a fourth aspect, a rheology modified composition comprising the following properties:
iii) a V0.1 (at 190° C.) ≥20 Pa·s, and
iv) a rheology ratio (RR=V0.1/V100, each at 190° C.) ≥1.1; and
wherein the rheology modified composition is formed from a composition as discussed above. In a fifth aspect, a composition comprising at least the following components a and b as discussed above:

Each process may comprise a combination of two or more embodiments, as described herein. Each component a and b may comprise a combination of two or more embodiments, as described herein. Each rheology modified composition may comprise a combination of two or more embodiments, as described herein. Each composition may comprise a combination of two or more embodiments, as described herein.

The following embodiments apply to the first through fifth aspects of the invention, unless stated otherwise.

In one embodiment, or a combination of two or more embodiments, each described here, component a has a density ≥0.854, or ≥0.856, or ≥0.858, or ≥0.860, or ≥0.862, or ≥0.864, or ≥0.866, or ≥0.868, or ≥0.870 g/cc (1 cc=1 cm³). In one embodiment, or a combination of two or more embodiments, each described herein, component a has a density ≤0.960, or ≤0.955, or ≤0.950, or ≤0.945, or ≤0.940, or ≤0.935, or ≤0.930, or ≤0.925, or ≤0.920, or ≤0.915, or ≤0.910, or ≤0.905, or ≤0.900, or ≤0.895, or ≤0.890, or ≤0.885, or ≤0.880, or ≤0.878, or ≤0.876, or ≤0.874, or ≤0.873, or 0.872 g/cc.

In one embodiment, or a combination of two or more embodiments, each described herein, component a is an ethylene-based polymer.

In one embodiment, or a combination of two or more embodiments, each described herein, component a is selected from a telechelic polyolefin of the formula A¹L¹L²A², or an unsaturated polyolefin of the formula A¹L¹. In a further embodiment, the L¹ of the telechelic polyolefin of the formula A¹L¹L²A² is an ethylene/alpha-olefin copolymer structure bonded to A¹ and L², and the L¹ of the unsaturated polyolefin of the formula A¹L¹ is an ethylene/alpha-olefin copolymer structure bonded to A¹. In a further embodiment, for each ethylene/alpha-olefin copolymer structure, the alpha-olefin is independently selected from the group consisting of propylene, 1-butene, 1-hexene, and 1-octene. Preferably, each L¹ is independently a random interpolymer and further a random copolymer.

In one embodiment, or a combination of two or more embodiments, each described herein, component a has a molecular weight distribution MWD (=Mw/Mn) ≥1.80, or ≥1.90, or ≥2.00, or ≥2.10, or ≥2.15, or ≥2.20, or ≥2.25, or ≥2.30, or ≥2.35, or ≥2.40. In one embodiment, or a combination of two or more embodiments, each described herein, component a has a molecular weight distribution MWD ≤3.00, or ≤2.90, or ≤2.80, or ≤2.70, or ≤2.65 or ≤2.60, or ≤2.55. Note, MWD, Mn, Mw and Mz determined from conventional GPC (see “Test Methods” below).

In one embodiment, or a combination of two or more embodiments, each described herein, component a has a V0.1 (at 190° C.) ≥10 Pa·s, or ≥50 Pa·s, or ≥100 Pa·s or ≥200 Pa·s, or ≥500 Pa·s, or ≥800 Pa·s, or ≥1000 Pa·s, or ≥1200 Pa·s, or ≥1400 Pa·s, or ≥1500 Pa·s. In one embodiment, or a combination of two or more embodiments, each described herein, component a has a V0.1 (at 190° C.) ≤100,000 Pa·s, or ≤50,000 Pa·s, or ≤20,000 Pa·s, or ≤10,000 Pa·s, or ≤9,000 Pa·s, or ≤8,000 Pa·s, or ≤7,000 Pa·s, or ≤6,000 Pa·s.

In one embodiment, or a combination of two or more embodiments, each described herein, component a has a rheology ratio (RR=V0.1/V100, each at 190° C.) ≥1.0, or ≥1.5, or ≥1.6, or ≥1.7, or ≥1.8, or ≥1.9, or ≥2.0, or ≥2.1. In one embodiment, or a combination of two or more embodiments, each described herein, component a has a rheology ratio (RR=V0.1/V100, each at 190° C.) ≤20, or ≤15, or ≤10, or ≤8.0, or ≤6.0, or ≤5.5, or ≤5.2, or ≤5.0, or ≤4.8, or ≤4.6, or ≤4.5.

In one embodiment, or a combination of two or more embodiments, each described herein, component a has a % vinyl ≥20%, or ≥25%, or ≥30%, or ≥35%, where % vinyl=[(vinyL/1000C)/(total unsaturation/1000 C)]×100. In one embodiment, or a combination of two or more embodiments, each described herein, component a has a % vinyl ≤80%, or ≤75%, or ≤70%.

Also provided is a rheology modified composition formed from a process of one or more embodiments as described herein.

In one embodiment, or a combination of two or more embodiments, each described herein, the rheology modified composition has a V0.1 (at 190° C.) ≥20 Pa·s, or ≥100 Pa·s, or ≥1000 Pa·s, or ≥2000 Pa·s, or ≥5,000 Pa·s, or ≥5,100 Pa·s, or ≥5,200 Pa·s, or ≥5,300 Pa·s, or ≥5,400 Pa·s, or ≥5,500 Pa·s. In one embodiment, or a combination of two or more embodiments, each described herein, the rheology modified composition has a V0.1 (at 190° C.) ≤1,000,000 Pa·s, or ≤500,000 Pa·s, or ≤200,000 Pa·s, or ≤100,000, or ≤50,000 Pa·s, or ≤20,000 Pa·s, or ≤18,000 Pa·s, or ≤16,000 Pa·s, or ≤14,000 Pa·s, or ≤12,000 Pa·s, or ≤11,000 Pa·s.

In one embodiment, or a combination of two or more embodiments, each described herein, the rheology modified composition has a rheology ratio (RR=V0.1/V100, each at 190° C.) ≥1.1, or ≥2.0, or ≥3.0, or ≥4.0, or ≥4.5, or ≥5.0, or ≥5.2, or ≥5.4, or ≥5.6, or ≥5.8, or ≥5.9, or ≥6.0, or ≥6.1, or ≥6.2. In one embodiment, or a combination of two or more embodiments, each described herein, the rheology modified composition has a rheology ratio (RR=V0.1/V100, each at 190° C.) ≤100, or ≤50, or ≤20, or ≤15, or ≤10, ≤9.5, ≤9.0, ≤8.5, ≤8.0.

In one embodiment, or a combination of two or more embodiments, each described herein, the rheology modified composition meets the following relationship: ΔV0.1 ≥50%, or ≥60%, or ≥70%, ≥80%, or ≥90%, or ≥100%, or ≥120%, or ≥150%, ≥200%, or ≥250%; and where ΔV0.1=[(V0.1_{(RM Composition)}−V0.1_{(Composition)})/(V0.1_{(Composition)})]×100], where “RM Composition” is the rheology modified composition and “Composition” is the composition before rheology modification, and V0.1 is the complex viscosity at 0.1 rad/s, in units of Pa·s, and measured at 190° C.

In one embodiment, or a combination of two or more embodiments, each described herein, the rheology modified composition meets the following relationship: ΔRR≥50%, or ≥60%, or ≥70%, ≥80%, or ≥90%, or ≥100%, or ≥150%, ≥200%; and where ΔRR=[(RR_{(RM Composition)}−RR_{(Composition)})/(RR_{(Composition)})]×100], where “RM Composition” is the rheology modified composition and “Composition” is the composition before rheology modification, and RR=V0.1/V100, and V0.1 and V100 are each measured at 190° C.

In one embodiment, or a combination of two or more embodiments, each described herein, the rheology modified composition meets the following relationship: Δtan delta (0.1) ≤−30%, or ≤−35%, or ≤−40%, ≤−42%, or ≤−44%, or ≤−46%, or ≤−48%, ≤−50%, or ≤−60%, or ≤−70%, or ≤−80%; and where Δtan delta (0.1)={[(tan delta (0.1)_{(RM Composition)}−tan delta (0.1)_{(composifion)})/(tan delta (0.1)_{(Composition)})]}×100, where “RM Composition” is the rheology modified composition and “Composition” is the composition before rheology modification, and tan delta (0.1) is measured at 0.1 rad/s and 190° C.

In one embodiment, or a combination of two or more embodiments, each described herein, the rheology modified composition has a total unsaturation ≥0.20/1000 C, or ≥0.25/1000 C, or ≥0.30/1000 C, or ≥0.35/1000 C, or ≥0.40/1000 C, or ≥0.45/1000 C. In one embodiment, or a combination of two or more embodiments, each described herein, the rheology modified composition has a total unsaturation ≤15.0/1000 C, or ≤10.0/1000 C, or ≤8.0/1000 C, or ≤5.00/1000 C, or ≤2.00/1000 C, or ≤1.50/1000 C, or ≤1.00/1000 C, or ≤0.95/1000 C, or ≤0.90/1000 C, or ≤0.85/1000 C.

In one embodiment, or a combination of two or more embodiments, each described herein, the rheology modified composition has a % vinyl ≥20%, or ≥25%, or ≥30%, or ≥35%, where % vinyl=[(vinyl/1000 C)/(total unsaturation/1000 C)]×100. In one embodiment, or a combination of two or more embodiments, each described herein, the rheology modified composition has a % vinyl ≤70%, or ≤65%, or ≤60%.

In one embodiment, or a combination of two or more embodiments, each described herein, the rheology modified composition has a molecular weight distribution MWD (=Mw/Mn) ≥2.00, or ≥2.10, or ≥2.15, or ≥2.20, or ≥2.25, or ≥2.30, or ≥2.35, or ≥2.40, or ≥2.45, or ≥2.50, or ≥2.55, or ≥2.60, or ≥2.65, or ≥2.70, or ≥2.75, or ≥2.80. In one embodiment, or a combination of two or more embodiments, each described herein, the rheology modified composition has a molecular weight distribution MWD ≤4.00, or ≤3.50, or ≤3.45, or ≤3.40, or ≤3.35, or ≤3.30, or ≤3.25, or ≤3.20 or ≤3.15, or ≤3.10.

In one embodiment, or a combination of two or more embodiments, each described herein, the rheology modified composition has a melt index (I2) ≥0.1 dg/min, or ≥0.2 dg/min, or ≥0.4 dg/min, or ≥0.6 dg/min, or ≥0.8 dg/min, or ≥1.0 dg/min, or ≥1.2 dg/min. In one embodiment, or a combination of two or more embodiments, each described herein, the rheology modified composition has a melt index (I2) ≤2000 dg/min, or ≤1000 dg/min, or ≤500 dg/min, or ≤200 dg/min, or ≤100 dg/min, or ≤70 dg/min, or ≤50 dg/min, or ≤20 dg/min, or ≤10 dg/min, or ≤5.0 dg/min, or ≤4.0 dg/min, or ≤3.5 dg/min, or ≤3.0 dg/min, or ≤2.5 dg/min, or ≤2.0 dg/min.

In one embodiment, or a combination of two or more embodiments, each described herein, the radiation is applied in an ambient air environment. In a further embodiment, the radiation is applied using a linear electron beam accelerator. In a further embodiment, the linear electron beam accelerator operates at an energy range of 4.5 MeV, a beam power (over the whole energy range) of 150 kW, a beam energy spread of +/−10 percent, and an average current of 30 milliamps (mA).

Also provided is an article comprising at least one component formed from a composition of one or more embodiments as described herein.

### Olefin-Based Polymers

Olefin-based polymers include, but are not limited to, telechelic polyolefins of the formula A¹L¹L²A², unsaturated polyolefins of the formula A¹L¹, and ethylene/alpha-olefin interpolymers.

Ethylene/alpha-olefin interpolymers comprise, in polymerized form, ethylene, and an alpha-olefin. Alpha-olefins include, but are not limited to, a C3-C20 alpha-olefins, further C3-C10 alpha-olefins, further C3-C8 alpha-olefins, such as propylene, 1-butene, 1-hexene, and 1-octene.

Telechelic polyolefins, such as those of the A¹L¹L²A² (Formula I), and unsaturated polyolefins, such as those of the A¹L¹ (Formula II), are each described below. See also WO 2020/140058 and WO 2020/140067, each incorporated herein by reference.

Telechelic polyolefin of Formula I: A¹L¹L²A², wherein: L¹ is a polyolefin (or polyolefin structure), and preferably an ethylene-based polymer, and further an ethylene/alpha-olefin interpolymer, and further an ethylene/alpha-olefin copolymer (structure); note, L¹ (divalent) is bonded to A¹ and L². A¹ is selected from the group consisting of the following:
a) a vinyl group, b) a vinylidene group of the formula CH₂=C(Y¹)—, c) a vinylene group of the formula Y¹CH=CH—, d) a mixture of a vinyl group and a vinylene group of the formula Y¹CH=CH—, e) a mixture of a vinyl group and a vinylidene group of the formula CH₂=C(Y¹)—, f) a mixture of a vinylidene group of the formula CH₂=C(Y¹)— and a vinylene group of the formula Y¹CH=CH—, and g) a mixture of a vinyl group, a vinylidene group of the formula CH₂=C(Y¹)—, and a vinylene group of the formula Y¹CH=CH—;
Y¹ at each occurrence, independently, is a C₁ to C₃₀ hydrocarbyl group;
L² is a C₁ to C₃₂ hydrocarbylene group; and
A² is a hydrocarbyl group comprising a hindered double bond.

Unsaturated polyolefin of Formula II: A¹L¹, wherein:
L¹ is polyolefin (or polyolefin structure), and preferably an ethylene-based polymer, and further an ethylene/alpha-olefin interpolymer, and further an ethylene/alpha-olefin copolymer; note, L¹ (monovalent) is bonded to A¹; A¹ is selected from the group consisting of the following: a) a vinyl group, b) a vinylidene group of the formula CH₂=C(Y¹)—, c) a vinylene group of the formula Y¹CH=CH—, d) a mixture of a vinyl group and a vinylene group of the formula Y¹CH=CH—, e) a mixture of a vinyl group and a vinylidene group of the formula CH₂=C(Y¹)—, f) a mixture of a vinylidene group of the formula CH₂=C(Y¹)— and a vinylene group of the formula Y¹CH=CH—, and g) a mixture of a vinyl group, a vinylidene group of the formula CH₂=C(Y¹)—, and a vinylene group of the formula Y¹CH=CH—; and
Y1 at each occurrence, independently, is a C₁ to C₃₀ hydrocarbyl group.

For Formula I and Formula II, L¹ at each occurrence independently is a polyolefin (or polyolefin structure), as described above, and may result, in part, from the polymerization (for example, coordination polymerization) of unsaturated monomers (and comonomers). Examples of suitable monomers (and comonomers) include, but are not limited to, ethylene and alpha-olefins of 3 to 30 carbon atoms, further 3 to 20 carbon atoms, such as, for example, propylene, 1-butene, 1-pentene, 3-methyl-1-butene, 1-hexene, 4-methyl-1-pentene, 3-methyl-1-pentene, 3,5,5-trimethyl-1hexene, 1-octene, 1-decene, 1-dodecene, 1-tetradecene, 1-hexadecene, 5-ethyl-1-nonene, 1-octadecene and 1-eicosene; conjugated or nonconjugated dienes, such as, for example, butadiene, isoprene, 4-methyl-1,3-pentadiene, 1,3-pentadiene, 1,4-pentadiene, 1,5-hexadiene, 1,4-hexadiene, 1,3-hexadiene, 1,5-heptadiene, 1,6-heptadiene, 1,3-octadiene, 1,4-octadiene, 1,5-octadiene, 1,6-octadiene, 1,7-octadiene, 1,9-decadiene, 7-methyl-1,6-octadiene, 4-ethylidene-8-methyl-1,7-nonadiene, 5,9-dimethyl-1,4,8-decatriene, 5-methyl-1,4-hexadiene, 3,7-dimethyl-1,6-octadiene, 3,7-dimethyl-1,7-octadiene, and mixed isomers of dihydromyrcene and dihydroocimene; norbornene and alkenyl, alkylidene, cycloalkenyl and cycloalkylidene norbornenes, such as 5-ethylidene-2-norbornene, 5-vinyl-2-norbornene, dicyclopentadiene, 5-methylene-2-norbornene, 5-propenyl-2-norbornene, 5-isopropylidene-2-norbornene, 5-(4-cyclopentenyl)-2-norbornene, 5-cyclohexylidene-2-norbornene, and norbornadiene; and aromatic vinyl compounds such as styrenes, mono or polyalkylstyrenes (including styrene, o-methylstyrene, t-methylstyrene, m-methylstyrene, p-methylstyrene, o-dimethylstyrene, o-ethylstyrene, m-ethylstyrene and p-ethylstyrene).

### Peroxide

As used herein, a peroxide contains at least one oxygen-oxygen bond (O—O). Peroxides include, but are not limited to, dialkyl, diaryl, dialkaryl, or diaralkyl peroxides, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.

Organic peroxides include, but are not limited to, tert-butylperoxy-2-ethylhexyl carbonate (TBEC); tert-amylperoxy-2-ethylhexyl carbonate (TAEC); tert-amylperoxy isopropyl carbonate; tert-butylperoxy isopropyl carbonate; 1,1-di(tert-butyl-peroxy) cyclohexane; 1,1-bis(tert-butylperoxy)-3,3,5-trimethylcyclohexane; 1,1-di(tert-amyl-peroxy)cyclohexane; dibenzoyl peroxide; dicumyl peroxide (“DCP”); tert-butylperoxy-benzoate; di-tert-amyl peroxide (“DTAP”); bis(t-butyl-peroxy isopropyl) benzene (“BIPB”); isopropylcumyl t-butyl peroxide; t-butyl-cumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy)-3,3,5-trimethylcyclohexane; isopropylcumyl cumylperoxide; butyl-4,4-di(tert-butylperoxy)valerate; di(isopropylcumyl) peroxide; 3,6,9-triethyl-3,6,9-trimethyl-1,4,7-triperoxonane; and mixtures of two or more thereof. A suitable peroxide is TRIGONOX 301.

### Additives

An inventive composition may comprise one or more additives. Additives include, but are not limited to, fillers, pigments, UV stabilizers, anti-oxidants, processing aids, and further fillers, pigments, UV stabilizers, and anti-oxidants.

### Definitions

Unless stated to the contrary, implicit from the context, or customary in the art, all parts and percentages are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as, for example, ethylene or propylene (based on the weight of the polymer), and optionally may comprise one or more comonomers. As used herein, olefin-based polymers include, but are not limited to, telechelic polyolefins of the formula A¹L¹L²A², unsaturated polyolefins of the formula A¹L¹, and ethylene/alpha-olefin interpolymers.

The term “polyolefin,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to an interpolymer that comprises, in polymerized form, 50 wt % or a majority weight percent of ethylene (based on the weight of the interpolymer), and an alpha-olefin. Preferably, the ethylene/alpha-olefin interpolymer is a random interpolymer (i.e., comprises a random distribution of its monomeric constituents).

The term, “ethylene/alpha-olefin copolymer,” as used herein, refers to a copolymer that comprises, in polymerized form, 50 wt % or a majority weight percent of ethylene (based on the weight of the copolymer), and an alpha-olefin, as the only two monomer types. Preferably, the ethylene/alpha-olefin copolymer is a random copolymer (i.e., comprises a random distribution of its monomeric constituents).

The phrase “a majority weight percent,” as used herein, in reference to a polymer (or interpolymer, or terpolymer or copolymer), refers to the amount of monomer present in the greatest amount in the polymer.

The term “rheology modified composition,” as used herein, refers to a composition that comprises a polymer that has a change (modification) in chemical bonds within and/or between polymer chains, such as formation of long chain branches, as a result of free radical generation, followed by free-radical reactions of polymer chains, for example, the coupling of two free radicals. The free radicals are formed by the application of radiation (for example, e-beam) or by reaction with a chemical compound (for example, a peroxide). The degree of change in chemical bonds is indicated by an increase in the V0.1, RR, Mw and/or Mz (and further V0.1 and RR) in the modified polymer, relative to the unmodified polymer. See, for example, Tables 3A-4B below. A rheology modified polymer is typically ≥95 wt %, further ≥98 wt % (based on the weight of the modified polymer) soluble in a solvent, such as 1,2,4-trichloro-benzene or xylene.

The phrases “applying radiation,” “radiation treating,” “radiation treatment,” and similar phrases, as used herein, in reference to a composition comprising an olefin-based polymer as discussed above, refer to the exposure of the composition to radiation (for example, high-energy electron beam).

The terms “electron beam radiation” and “e-beam,” as used herein, refer to the generation of an electron beam from, for example, a heated cathode filament (typically tungsten). The electrons emitted from the cathode are accelerated in an electric field applied between the cathode and anode. The energy gain of the electron beam is proportional to the acceleration voltage. The energy is measured in eV (electron-volts), and accelerators up to 10 MeV are commercially available. The dosage of the e-beam is measured in megarad (MRad). When the e-beam enters a polymer, it ionizes and excites the molecules, resulting, for example, in the displacement of hydrogen atoms and formation of free radicals. The combination of two free radicals typically forms branching. The type of branching formed by this method is typically H-type or tetrafunctional. Although e-beam is a preferred method of applying radiation, gamma rays and X-rays can also be used as a source. Further the radiation may be applied in a batch or continuous process.

The phrases “applying heat,” “heat treating,” “heat treatment,” and similar phrases, as used herein, in reference to a composition comprising an olefin-based polymer, as discussed above, refer to heating the composition. Heat may be applied by electrical means (for example, a heating coil). Note, the temperature at which the heat treatment takes place, refers to the temperature of the composition (for example, the melt temperature of the composition).

The phrases “thermally treating,” “thermal treatment,” and similar phrases, as used herein, in reference to a composition comprising an olefin-based polymer, as discussed above, refer to increasing the temperature of the composition by the application of heat, radiation or other means (for example, a chemical reaction). Note, the temperature at which the thermal treatment takes place, refers to the temperature of the composition (for example, the melt temperature of the composition).

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include, for example, any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Processes and Compositions

A] A process to form a rheology modified composition, the process comprising applying radiation, and optionally heat, to a composition that comprises at least the following component:
a) an olefin-based polymer comprising a total unsaturation ≥0.20/1000 C; and wherein the radiation is applied using an electron beam (e-beam) at a dosage selected from 0.1 MRad to 1.5 MRad; and
wherein component a is selected from a telechelic polyolefin of the formula A¹L¹L²A², an unsaturated polyolefin of the formula A¹L¹, or an ethylene/alpha-olefin interpolymer.

B] A process to form a rheology modified composition, the process comprising applying heat, and optionally radiation, to a composition that comprises at least the following components:
a) an olefin-based polymer comprising a total unsaturation ≥0.20/1000 C;
b) from 1.0 to 100 ppm of a peroxide, based on the weight of the composition; and
wherein component a is selected from a telechelic polyolefin of the formula A¹L¹L²A², an unsaturated polyolefin of the formula A¹L¹, or an ethylene/alpha-olefin interpolymer.

C] The process of A] above, wherein the electron beam is applied at a dosage ≥0.2 MRad, or ≥0.3 MRad, or ≥0.4 MRad or ≥0.5 MRad, or ≥0.6 MRad, or ≥0.8 MRad.

D] The process of A] or C] above, wherein the electron beam is applied at a dosage ≤1.4 MRad, or ≤1.3 MRad, or ≤1.2 MRad, or ≤1.1 MRad.

E] The process of any one of A], C] or D] above, wherein the electron beam is applied at a beam power ≥100, or ≥110, or ≥120, or ≥130, or ≥140, or ≥145 kW.

F] The process of any one of A] or C]-E] above, wherein the electron beam is applied at a beam power ≤200, or ≤190, or ≤180, or ≤170, or ≤160, or ≤150 kW.

G] The process of any one of A] or C]-F] above, wherein the electron beam is applied at an energy range ≥3.0, or ≥3.5, or ≥4.0, or ≥4.1, or ≥4.2, or ≥4.3, or ≥4.4 MeV.

H] The process of any one of A] or C]-G] above, wherein the electron beam is applied at an energy range ≤5.0, or ≤4.9, or ≤4.8, or ≤4.7, or ≤4.6, or ≤4.5 MeV.

I] The process of any one of A] or C]-H] above, wherein the electron beam is applied at an average current ≥10, or ≥12, or ≥15, or ≥18, or ≥20, or ≥22, or ≥25, or ≥28 mA.

J] The process of any one of A] or C]-I] above, wherein the electron beam is applied at an average current ≤50, or ≤45, or ≤40, or ≤35, or ≤32 mA.

K] The process of any one of A] or C]-J] above, wherein the electron beam is applied in an ambient air environment.

L] The process of any one of A] or C]-K] above, wherein the beam energy spread is +/−15 percent, further +/−10 percent.

M] The process of any one of A] or C]-L] above, wherein the electron beam is applied using a linear electron beam accelerator.

N] The process of any one of A], C]-M] above, wherein the electron beam is applied for a time period ≥1, or ≥2, or ≥3, or ≥4, or ≥5, or ≥6, or ≥7, or ≥8, or ≥9, or ≥10 ms (millisecond).

0] The process of any one of A] or C]-N] above, wherein the electron beam is applied for a time period ≤100 ms, or ≤50 ms, or ≤30 ms, or ≤28 ms, or ≤26 ms, or ≤24 ms, or ≤22 ms, or ≤20 ms.

P] The process of B] above, wherein the peroxide is present in an amount ≥2.0 ppm, or ≥5.0 ppm , or ≥10 ppm, or ≥12 ppm, or ≥14 ppm, or ≥16 ppm, or ≥18 ppm, based on the weight of the composition.

Q] The process of B] or P] above, wherein the peroxide is present in an amount ≤90 ppm, or 80 ppm, or ≤70 ppm, or ≤60 ppm, or ≤50 ppm, or ≤40 ppm, or ≤35 ppm, or ≤30 ppm, or ≤28 ppm, or ≤26 ppm, or ≤24 ppm, or ≤22 ppm, based on the weight of the composition.

R] The process of any one of B], P] or Q], wherein the composition comprises ≥10.0 wt %, or ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt %, or ≥97.0 wt % of the sum of components a and b, based on the weight of the composition.

S] The process of any one of B] or P]-R] above, wherein the composition comprises ≤99.9 wt %, or ≤99.8 wt %, or ≤99.6 wt %, or ≤99.4 wt %, or ≤99.2 wt %, or ≤99.0 wt %, or ≤5 98.5 wt %, or ≤98.0 wt % of the sum of components a and b, based on the weight of the composition.

T] The process of any one of A]-S] (A] through S]) above, wherein component a has a total unsaturation ≥0.25/1000 C, or ≥0.30/1000 C, or ≥0.35/1000 C, or ≥0.40/1000 C, or ≥0.45/1000 C, or ≥0.50/1000 C, or ≥0.55/1000 C, or ≥0.60/1000 C, or ≥0.65/1000 C, or ≥0.70/1000 C, or ≥0.75/1000 C, or ≥0.80/1000 C.

U] The process of any one of A]-T] above, wherein component a has a total unsaturation ≤15.0/1000, or ≤10.0/1000 C, or ≤5.00/1000 C, or ≤2.00/1000 C, or ≤1.50/1000 C, or ≤1.00/1000 C.

V] The process of any one of A]-U] above, wherein component a is an ethylene-based polymer.

W] The process of any one of A]-V] above, wherein component a has a density ≥0.854, or ≥0.856, or ≥0.858, or ≥0.860, or ≥0.862, or ≥0.864, or ≥0.866, or ≥0.868, or ≥0.870 g/cc (1 cc=1 cm³).

X] The process of any one of A]-W] above, wherein component a has a density ≤0.960, or ≤0.955, or ≤0.950, or ≤0.945, or ≤0.940, or ≤0.935, or ≤0.930, or ≤0.925, or ≤0.920, or ≤0.915, or ≤0.910, or ≤0.905, or ≤0.900, or ≤0.895, or ≤0.890, or ≤0.885, or ≤or ≤0.880, or ≤0.878, or ≤0.876, or ≤0.874, or ≤0.873, or 0.872 g/cc.

Y] The process of any one of A]-X] above, wherein component a is selected from a telechelic polyolefin of the formula A¹L¹L²A², or an unsaturated polyolefin of the formula A¹L¹; and further, the L¹ of the telechelic polyolefin of the formula A¹L¹L²A² is an ethylene/alpha-olefin copolymer structure bonded to A¹ and L², and the L¹ of the unsaturated polyolefin of the formula A¹L¹ is an ethylene/alpha-olefin copolymer structure bonded to A¹; and further, for each ethylene/alpha-olefin copolymer structure, the alpha-olefin is independently selected from the group consisting of propylene, 1-butene, 1-hexene, and 1-octene. Preferably, the L¹ of A¹L¹L²A² is a random interpolymer structure and further a random copolymer structure. Preferably, the L¹ of A¹L¹ is a random interpolymer structure and further a random copolymer structure.

Z] The process of any one of A]-Y] above, wherein component a is a telechelic polyolefin of the formula A¹L¹L²A²; wherein L¹ is an ethylene-based polymer, further an ethylene/alpha-olefin interpolymer (preferably random), and further an ethylene/alpha-olefin copolymer (preferably random).

A2] The process of Z] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.

B2] The process of Z] or A2] above, wherein the telechelic polyolefin of the formula A¹L¹L²A² has a has a melt index (I₂) ≥0.1, or ≥0.2, or ≥0.5, or ≥1.0 dg/min, and/or ≤2000, or ≤1000, or ≤500, or ≤200, or ≤100, or ≤50, or ≤20, or ≤10, or ≤8.0, or ≤6.0 dg/min.

C2] The process of any one of A]-Y] above, wherein component a is an unsaturated polyolefin of the formula A¹L¹; wherein L¹ is an ethylene-based polymer, further an ethylene/alpha-olefin interpolymer (preferably random), and further an ethylene/alpha-olefin copolymer (preferably random).

D2] The process of C2] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.

E2] The process of C2] or D2] above, wherein the unsaturated polyolefin of the formula A¹L¹ has a has a melt index (I2) ≥0.1, or ≥0.2, or ≥0.5, or ≥0.8, or ≥1.0, or ≥2.0, or ≥4.0 dg/min, and/or ≤2000, or ≤1000, or ≤500, or ≤200, or ≤100, or ≤50, or ≤20, or ≤10, or ≤8.0, or ≤6.0 dg/min.

F2] The process of any one of A]-X] above, wherein component a is an ethylene/alpha-olefin interpolymer, and further an ethylene/alpha-olefin copolymer. Preferably, component a is a random interpolymer and further a random copolymer.

G2] The process of F2] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.

H2] The process of F2] or G2] above, wherein the ethylene/alpha-olefin interpolymer has a has a melt index (I2) ≥0.1, or ≥0.2, or ≥0.5, or ≥1.0, or ≥2.0, or ≥4.0 dg/min, and/or ≤2000, or ≤1000, or ≤500, or ≤200, or ≤100, or ≤50, or ≤20, or ≤10 dg/min.

I2] The process of any one of A]-H2] above, wherein component a has a melt index (I2) ≥0.1, or ≥0.2 , or ≥0.5, or ≥1.0, or ≥2.0, or ≥4.0 dg/min, and/or a melt index (I2) ≤2000, or ≤1000, or ≤500, or ≤200, or ≤100, or ≤50, or ≤20, or ≤10 dg/min.

J2] The process of any one of A]-I2] above, wherein component a has a molecular weight distribution MWD (=Mw/Mn) ≥1.80, or ≥1.90, or ≥2.00, or ≥2.10, or ≥2.15, or ≥2.20, or ≥2.25, or ≥2.30, or ≥2.35, or ≥2.40, and/or a MWD ≤3.00, or ≤2.90, or ≤2.80, or ≤2.70, or ≤2.65 or ≤2.60, or ≤2.55.

K2] The process of any one of A]-J2] above, wherein component a has a number average molecular weight Mn ≥5,000, or ≥10,000, or ≥15,000, or ≥20,000, or ≥22,000, or ≥24,000, or ≥26,000, or ≥28,000, or ≥30,000 g/mol, and/or an Mn ≤120,000, or ≤100,000, or ≤80,000, or ≤60,000, or ≤55,000, or ≤50,000, or ≤45,000, or ≤40,000 g/mol.

L2] The process of any one of A]-K2] above, wherein component a has a weight average molecular weight Mw ≥10,000, or ≥20,000, or ≥30,000, or ≥35,000, or ≥40,000, or ≥45,000, or ≥50,000, or ≥55,000, or ≥60,000, or ≥65,000, or ≥70,000, or ≥75,000 g/mol, and/or an Mw ≤300,000, or ≤200,000, or ≤150,000, or ≤140,000, or ≤130,000, or ≤120,000, or ≤110,000, or ≤100,000, or ≤95,000, or ≤90,000, or ≤85,000 g/mol.

M2] The process of any one of A]-L2] above, wherein component a has a z average molecular weight Mz ≥20,000, or ≥40,000, or ≥60,000, or ≥80,000, or ≥100,000, or ≥105,000, or ≥110,000, or ≥115,000, or ≥120,000, or ≥125,000, or ≥130,000, or ≥135,000, or ≥140,000, or ≥145,000, or ≥150,000 g/mol, and/or an Mz ≤500,000, or ≤400,000, or ≤300,000, or ≤250,000, or ≤240,000, or ≤230,000, or ≤220,000, or ≤210,000, or ≤200,000, or ≤195,000, or ≤190,000, or ≤185,000, or ≤180,000.

N2] The process of any one of A]-M2] above, wherein component a has a V0.1 (at 190° C.) ≥10 Pa·s, or ≥50 Pa·s, or ≥100 Pa·s or ≥200 Pa·s, or ≥500 Pa·s, or ≥800 Pa·s, or ≥1000 Pa·s, or ≥1200 Pa·s, or ≥1400 Pa·s, or ≥1500 Pa·s.

O2] The process of any one of A]-N2] above, wherein the component a has a V0.1 (at 190° C.) ≤100,000 Pa·s, or ≤50,000 Pa·s, or ≤20,000 Pa·s, or ≤10,000 Pa·s, or ≤9,000 Pa·s, or ≤8,000 Pa·s, or ≤7,000 Pa·s, or ≤6,000 Pa·s.

P2] The process of any one of A]-O2] above, wherein component a has a rheology ratio (RR=V0.1/V100, each at 190° C.) ≥1.0, or ≥1.5, or ≥1.6, or ≥1.7, or ≥1.8, or ≥1.9, or ≥2.0, or ≥2.1.

Q2] The process of any one of A]-P2] above, wherein component a has a rheology ratio (RR=V0.1/V100, each at 190° C.) ≤20, or ≤15, or ≤10, or ≤8.0, or ≤6.0, or ≤5.5, or ≤5.2, or ≤5.0, or ≤4.8, or ≤4.6, or ≤4.5.

R2] The process of any one of A]-Q2] above, wherein component a has a V100 (at 190° C.) ≥10 Pa·s, or ≥50 Pa·s, or ≥100 Pa·s, or ≥200 Pa·s, or ≥500 Pa·s, or ≥550 Pa·s, or ≥600 Pa·s, or ≥650 Pa·s, or ≥700 Pa·s.

S2] The process of any one of A]-R2] above, wherein component a has a V100 (at 190° C.) ≤20,000 Pa·s, or ≤10,000 Pa·s, or ≤5,000 Pa·s, or ≤2000 Pa·s, or ≤1800 Pa·s, or ≤1600 Pa·s, or ≤1500 Pa·s, or ≤1400 Pa·s.

T2] The process of any one of A]-S2] above, wherein component a has a tan delta (0.1 rad/s, 190° C.) ≥3.0, or ≥3.5, or ≥4.0, or ≥4.5, or ≥5.0, or ≥5.5, or ≥6.0, or ≥7.0, or ≥8.0, or ≥9.0, or ≥10.

U2] The process of any one of A]-T2] above, wherein component a has a tan delta (0.1 rad/s, 190° C.) ≤70, or ≤65, or ≤60, or ≤55.

V2] The process of any one of A]-U2] above, wherein component a has a tan delta (100 rad/s, 190° C.) ≥1.0, or ≥1.1, or ≥1.2, or ≥1.3, or ≥1.4, or ≥1.5, and/or a tan delta (100 rad/s, 190° C.) ≤2.0, or ≤1.9, or ≤1.8, or ≤1.7.

W2] The process of any one of A]-V2] above, wherein component a has a % vinyl ≥20%, or ≥25%, or ≥30%, or ≥35%, and/or ≤80%, or ≤75%, or ≤70%, where % vinyl=[(vinyl/1000 C)/(total unsaturation/1000 C)]×100.

X2] The process of any one of A]-W2] above, wherein component a has a % vinylidene ≥2.0%, or ≥2.5%, or ≥3.0%, or ≥3.5%, or ≥4.0%, or ≥5.0%, or ≥6.0%, or ≥7.0%, or ≥8.0%, or ≥9.0%, or ≥10% % vinylidene, and/or ≤30%, or ≤25%, or ≤20%, where % vinylidene=[(vinylidene/1000 C)/(total unsaturation/1000 C)]×100.

Y2] The process of any one of A]-X2] above, wherein component a has a % vinylene ≥0.5%, or ≥1.0%, or ≥1.5%, or ≥2.0%, and/or ≤6.0%, or ≤5.5%, or ≤5.0%, or ≤4.5% where % vinylene=[(vinylene/1000 C)/(total unsaturation/1000 C)]×100.

Z2] The process of any one of A]-Y2] above, wherein component a has a % trisubstituted content ≥0.1%, or ≥0.2%, or ≥0.3%, or ≥0.4%, and/or a % trisubstituted content ≤5.0%, or ≤4.5%, or ≤4.0%, or ≤3.5%, or ≤3.0%, or ≤2.5%, or ≤3.0%, where % trisubstituted=[(trisubstituted/1000 C)/(total unsaturation/1000 C)]×100.

A3] The process of any one of A]-Z2] above, wherein the composition is thermally treated at a temperature ≥20° C., or ≥25° C., or ≥30° C., or ≥35° C., or ≥40° C., or ≥45° C., and/or ≤200° C., or ≤180° C., or ≤150° C., or ≤120° C., or ≤100° C., or ≤80° C., or ≤60° C., or ≤50° C.

B3] A rheology modified composition formed from the process of any one of A]-A3].

C3] The rheology modified composition of B3] above, wherein the rheology modified composition has a V0.1 (at 190° C.) ≥20 Pa·s, or ≥50 Pa·s, or ≥100 Pa·s, or ≥1000 Pa·s, or ≥2000 Pa·s, or ≥5,000 Pa·s, or ≥5,100 Pa·s, or ≥5,200 Pa·s, or ≥5,300 Pa·s, or ≥5,400 Pa·s, or ≥5,500 Pa·s.

D3] The rheology modified composition of B3] or C3] above, wherein the rheology modified composition has a V0.1 (at 190° C.) ≤1,000,000 Pa·s, or ≤500,000 Pa·s, or ≤200,000 Pa·s, or ≤100,000, or ≤50,000 Pa·s, or ≤20,000 Pa·s, or ≤18,000 Pa·s, or ≤16,000 Pa·s, or ≤14,000 Pa·s, or ≤12,000 Pa·s, or ≤11,000 Pa·s.

E3] The rheology modified composition of any one of B3]-D3] above, wherein the rheology modified composition has a rheology ratio (RR=V0.1/V100, each at 190° C.) ≥1.1, or ≥2.0, or ≥3.0, or ≥4.0, or ≥4.5, or ≥5.0, or ≥5.2, or ≥5.4, or ≥5.6, or ≥5.8, or ≥5.9, or ≥6.0, or ≥6.1, or ≥6.2.

F3] The rheology modified composition of any one of B3]-E3] above, wherein the rheology modified composition has a rheology ratio (RR=V0.1/V100, each at 190° C.) ≤100, or ≤50, or ≤20, or ≤15, or ≤10, or ≤9.5, ≤9.0, ≤8.5, ≤8.0, or ≤7.9.

G3] A rheology modified composition comprising the following properties:
v) a V0.1 (at 190° C.) ≥20 Pa·s, and
vi) a rheology ratio (RR=V0.1/V100, each at 190° C.) ≥1.1; and
wherein the rheology modified composition is formed from a composition comprising an olefin-based polymer that comprises a total unsaturation ≥0.20/1000 C; and
wherein the olefin-based polymer is selected from a telechelic polyolefin of the formula A¹L¹L²A², an unsaturated polyolefin of the formula A¹L¹, or an ethylene/alpha-olefin interpolymer.

H3] The rheology modified composition of G3] above, wherein the rheology modified composition has a V0.1 (at 190° C.) ≥50 Pa·s, or ≥100 Pa·s, or ≥500 Pa·s, or ≥1,000 Pa·s, or ≥2,000 Pa·s, or ≥5,000 Pa·s, or ≥5,100 Pa·s, or ≥5,200 Pa·s, or ≥5,300 Pa·s, or ≥5,400 Pa·s, or ≥5,500 Pa·s, and/or a V0.1 (at 190° C.) ≤1,000,000 Pa·s, or ≤500,000 Pa·s, or ≤200,000 Pa·s, or ≤100,000 Pa·s, or ≤50,000 Pa·s, or ≤20,000 Pa·s, or ≤18,000 Pa·s, or ≤16,000 Pa·s, or ≤14,000 Pa·s, or ≤12,000 Pa·s, or ≤11,000 Pa·s.

I3] The rheology modified composition of any one of G3] or H3] above, wherein the rheology modified composition has a rheology ratio (RR=V0.1/V100, each at 190° C.) ≥2.0, or ≥3.0, or ≥4.0, or ≥4.5, or ≥5.0, or ≥5.2, or ≥5.4, or ≥5.6, or ≥5.8, or ≥5.9, or ≥6.0, or ≥6.1, or ≥6.2, and/or a rheology ratio (RR=V0.1/V100, each at 190° C.) ≤100, or ≤50, or ≤20, or ≤15, or ≤10, or ≤9.5, or ≤9.0, or ≤8.5, or ≤8.0, or ≤7.9.

J3] The rheology modified composition of any one of B3]-I3] above, wherein the rheology modified composition has a V100 (at 190° C.) ≥500 Pa·s, or ≥550 Pa·s, or ≥600 Pa·s, or ≥650 Pa·s, or ≥700 Pa·s, or ≥750 Pa·s, or ≥800 Pa·s, or ≥820 Pa·s, or ≥840 Pa·s, or ≥860 Pa·s, and/or a V100 (at 190° C.) ≤3,000 Pa·s, or ≤2,800 Pa·s, or ≤2,500 Pa·s, or ≤2,000 Pa·s, or ≤1,800 Pa·s, or ≤1,600 Pa·s, or ≤1,500 Pa·s.

K3] The rheology modified composition of any one of B3]-J3] above, wherein the rheology modified composition has a tan delta (0.1 rad/s, 190° C.) ≥2.0, or ≥2.2, or ≥2.4, or ≥2.6, or ≥2.8, or ≥3.0, and/or a tan delta (0.1 rad/s, 190° C.) ≤6.0, or ≤5.9, or ≤5.8, or ≤5.7, or ≤5.6, or ≤5.5, or ≤5.4, or ≤5.3, or ≤5.2.

L3] The rheology modified composition of any one of B3]-K3] above, wherein the rheology modified composition has a tan delta (100 rad/s, 190° C.) ≥0.8, or 0.9, or ≥1.0, or ≥1.1, and/or a tan delta (100 rad/s, 190° C.) ≤1.6, or ≤1.5, or ≤1.4, or ≤1.3.

M3] The rheology modified composition of any one of B3]-L3] above, or the process of any one of A]-A3] above, wherein the rheology modified composition meets the following relationship: ΔV0.1 ≥50%, or ≥60%, or ≥70%, ≥80%, or ≥90%, or ≥100%, or ≥120%, or ≥150%, ≥200%, or ≥250%; and where ΔV0.1=[(V0.1_{(RM composition)}−V0.1_{(composition)})/(V0.1_{(composition)})]×100], where “RM Composition” is the rheology modified composition and “Composition” is the composition before rheology modification, and V0.1 is the complex viscosity at 0.1 rad/s, in units of Pa·s, measured at 190° C.

N3] The rheology modified composition of any one of B3]-M3] above, or the process of any one of A]-A3] or M3] above, wherein the rheology modified composition meets the following relationship: ΔV0.1 ≤500%, or ≤400%, or ≤300%; and where ΔV0.1=[(V0.1_{(RM Composition)}−V0.1_{(Composition)})/(V0.1_{(Composition)})]×100].

O3] The rheology modified composition of any one of B3]-N3] above, or the process of any one of A]-A3], M3] or N3] above, wherein the rheology modified composition meets the following relationship: ΔRR ≥50%, or ≥60%, or ≥70%, ≥80%, or ≥90%, or ≥100%, or ≥150%, ≥200%; and where ΔRR=[(RR_{(RM Composition)}−RR_{(Composition)})/(RR_{(Composition)})]×100], where “RM Composition” is the rheology modified composition and “Composition” is the composition before rheology modification, and RR=V0.1/V100, and V0.1 and V100 are each measured at 190° C.

P3] The rheology modified composition of any one of B3]-O3] above, or the process of any one of A]-A3] or M3]-O3] above, wherein the rheology modified composition meets the following relationship: ΔRR ≤500%, or ≤400%, or ≤300%; and where ΔRR=[(RR_{(RM Composition)}−RR_{(Composition)})/(RR_{(Composition)})]×100].

Q3] The rheology modified composition of any one of B3]-P3] above, or the process of any one of A]-A3] or M3]-P3] above, wherein the rheology modified composition meets the following relationship: Δtan delta (0.1) ≤−30%, or ≤−35%, or ≤−40%, ≤−42%, or ≤−44%, or ≤−46%, or ≤−48%, ≤−50%, or ≤−60%, or ≤−70%, or ≤−80%; and where Δtan delta (0.1)={[(tan delta (0.1)_{(RM Composition)}−tan delta (0.1)_{(Composition)})/(tan delta (0.1)_{(Composition)})]}×100, where “RM Composition” is the rheology modified composition and “Composition” is the composition before rheology modification, and tan delta (0.1) is measured at 0.1 rad/s and 190° C.

R3] The rheology modified composition of any one of B3]-Q3] above, or the process of any one of A]-A3] or M3]-Q3] above, wherein the rheology modified composition meets the following relationship: Δtan delta (0.1) ≥−100%, or ≥−98%, or ≥−95%; and where Δtan delta(0.1)={[(tan delta (0.1)_{(RM Composition)}−tan delta(0.1)_{(Composition)})/(tan delta(0. 1)_{(Composition)})]}×100.

S3] The rheology modified composition of any one of B3]-R3] above, or the process of any one of A]-A3] or M3]-R3] above, wherein the rheology modified composition has a total unsaturation ≥0.20/1000 C, or ≥0.25/1000 C, or ≥0.30/1000 C, or ≥0.35/1000 C, or ≥0.40/1000 C, or ≥0.45/1000 C.

T3] The rheology modified composition of any one of B3]-S3] above, or the process of any one of A]-A3] or M3]-S3] above, wherein the rheology modified composition has a total unsaturation ≤15.0/1000 C, or ≤10.0/1000 C, or ≤8.0/1000 C, or ≤5.00/1000 C, or ≤2.00/1000 C, or ≤1.50/1000 C, or ≤1.00/1000 C, or ≤0.95/1000 C, or ≤0.90/1000 C, or ≤0.85/1000 C.

U3] The rheology modified composition of any one of B3]-T3] above, or the process of any one of A]-A3] or M3]-T3] above, wherein the rheology modified composition has a % vinyl ≥20%, or ≥25%, or ≥30%, or ≥35%, and/or ≤70%, or ≤65%, or ≤60%, where % vinyl=[(vinyl/1000 C)/(total unsaturation/1000 C)]×100.

V3] The rheology modified composition of any one of B3]-U3] above, or the process of any one of A]-A3] or M3]-U3] above, wherein the rheology modified composition has a % vinylidene ≥2.0%, or ≥3.0%, or ≥5.0%, or ≥10%, and/or ≤30%, or ≤25%, or ≤20%, where % vinylidene=[(vinylidene/1000 C)/(total unsaturation/1000 C)]×100.

W3] The rheology modified composition of any one of B3]-V3] above, or the process of any one of A]-A3] or M3]-V3] above, wherein the rheology modified composition has a % vinylene ≥0.5%, or ≥1.0%, or ≥1.5%, or ≥2.0%, and/or ≤10%, or ≤9.0%, or ≤8.0%, where % vinylene=[(vinylene/1000 C)/(total unsaturation/1000 C)]×100.

X3] The rheology modified composition of any one of B3]-W3] above, or the process of any one of A]-A3] or M3]-W3] above, wherein the rheology modified composition has a % trisubstituted ≥0.1%, or ≥0.2%, or ≥0.3%, or ≥10%, and/or ≤5.0%, or ≤4.5%, or ≤4.0%, or ≤3.5%, where % trisubstituted=[(trisubstituted/1000 C)/(total unsaturation/1000 C)]×100.

Y3] The rheology modified composition of any one of B3]-X3] above, or the process of any one of A]-A3] or M3]-X3] above, wherein the rheology modified composition has a molecular weight distribution MWD (=Mw/Mn) ≥2.00, or ≥2.10, or ≥2.15, or ≥2.20, or ≥2.25, or ≥2.30, or ≥2.35, or ≥2.40, or ≥2.45, or ≥2.50, or ≥2.55, or ≥2.60, or ≥2.65, or ≥2.70, or ≥2.75, and/or ≤4.00, or ≤3.50, or ≤3.45 ≤3.40, or ≤3.35, or ≤3.30, or ≤3.25, or ≤3.20 or ≤3.15, or ≤3.10.

Z3] The rheology modified composition of any one of B3]-Y3] above, or the process of any one of A]-A3] or M3]-Y3] above, wherein the rheology modified composition has a number average molecular weight Mn ≥10,000, or ≥12,000, or ≥14,000, or ≥16,000, or ≥18,000, or ≥20,000, or ≥22,000, or ≥24,000 g/mol, or ≥26,000, or ≥28,000, or ≥30,000 g/mol, and/or ≤60,000, or ≤55,000, or ≤50,000, or ≤45,000, or ≤42,000, or ≤40,000 g/mol.

A4] The rheology modified composition of any one of B3]-Z3] above, or the process of any one of A]-A3] or M3]-Z3] above, wherein the rheology modified composition has a weight average molecular weight Mw ≥70,000, or ≥75,000, or ≥80,000, or ≥85,000 , or ≥88,000 g/mol, and/or ≤200,000, or ≤180,000, or ≤170,000, or ≤160,000, or ≤150,000, or ≤140,000, or ≤130,000, or ≤125,000, or ≤120,000, or ≤115,000, or ≤110,000 g/mol.

B4] The rheology modified composition of any one of B3]-A4] above, or the process of any one of A]-A3] or M3]-A4] above, wherein the rheology modified composition has a z average molecular weight Mz ≥140,000, or ≥160,000, or ≥180,000 g/mol, and/or ≤400,000, or ≤350,000, or ≤300,000, or ≤290,000, or ≤285,000, or ≤280,000, or ≤275,000 g/mol.

C4] The rheology modified composition of any one of B3]-B4] above, or the process of any one of A]-A3] or M3]-B4] above, wherein the rheology modified composition meets the following relationship: ΔMw ≥5.0%, or ≥6.0%, or ≥7.0%, ≥8.0%, or ≥9.0%, or ≥10%, or ≥12%, or ≥14%; and/or ΔMw ≤30%, or ≤28%, or ≤26%, or ≤24%, or ≤22%; and where ΔMw=[(Mw_{(RM Composition)}−Mw_{(Composition)})/(Mw_{(Composition)})]×100], where “RM Composition” is the rheology modified composition and “Composition” is the composition before rheology modification; Mw (g/mol)=weight average molecular weight.

D4] The rheology modified composition of any one of B3]-C4] above, or the process of any one of A]-A3] or M3]-C4] above, wherein the rheology modified composition meets the following relationship: ΔMz ≥10%, or ≥15%, or ≥20%, ≥or 22%, or ≥24%, or ≥26%, or ≥28%, or ≥30%, and/or ΔMz ≤60%, or ≤55%, or ≤50%, or ≤48%, or ≤46%; and where ΔMz=[(Mz_{(RM Composition)}−MZ_{(Composition)})/(MZ_{(Composition)})]×100], where “RM Composition” is the rheology modified composition and “Composition” is the composition before rheology modification, and Mz (g/mol)=z average molecular weight.

E4] The rheology modified composition of any one of B3]-D4] above, or the process of any one of A]-A3] or M3]-D4] above, wherein the rheology modified composition meets the following relationship: ΔMWD ≥5.0%, or ≥10%, or ≥11%, ≥12%, or ≥13%, or ≥14%, or ≥15%, ≥16%, and/or ΔMWD ≤35%, or ≤30%, or ≤28%, or ≤26%, or ≤24%; and where ΔMWD=[(MWD_{(RM Composition)}−MWD_{(Composition)})/(MWD_{(Composition)})]×100], where “RM Composition” is the rheology modified composition and “Composition” is the composition before rheology modification, and MWD=molecular weight distribution.

F4] The rheology modified composition of any one of B3]-E4] above, or the process of any one of A]-A3] or M3]-E4] above, wherein the rheology modified composition has a melt strength (MS), at 190° C., ≥3.0 cN, or ≥3.5 cN, or ≥4.0 cN, or ≥4.5 cN, or ≥5.0 cN.

G4] The rheology modified composition of any one of B3]-F4] above, or the process of any one of A]-A3] or M3]-F4] above, wherein the rheology modified composition has a melt strength (MS) at 190° C. ≤10 cN, or ≤9.0 cN, or ≤8.0 cN, or ≤7.0 cN, or ≤6.0 cN.

H4] The rheology modified composition of any one of B3]-G4] above, or the process of any one of A]-A3] or M3]-G4] above, wherein the rheology modified composition meets the following relationship: ΔMS ≥100%, or ≥105%, or ≥110%, ≥115%, or ≥120%, or ≥125%; and where ΔMS=[(MS_{(RM Composition)}−MS_{(Composition)})/(MS_{(Composition)})]×100], where “RM Composition” is the rheology modified composition and “Composition” is the composition before rheology modification, and MS, in cN, is the melt strength at 190° C.

I4] The rheology modified composition of any one of B3]-H4] above, or the process of any one of A]-A3] or M3]-H4] above, wherein the rheology modified composition meets the following relationship: ΔMS ≤200%, or ≤180%, or ≤150%, or ≤145%, or ≤140%; and where ΔMS=[(MS_{(RM Composition)}−MS_{(Composition)})/(MS_{(Composition)})]×100].

J4] The rheology modified composition of any one of B3]-I4] above, or the process of any one of A]-A3] or M3]-I4] above, wherein the rheology modified composition has a melt index (I2) ≥0.1, or ≥0.2, or ≥0.4, or ≥0.6, or ≥0.8, or ≥1.0, or ≥1.2 dg/min, and/or ≤2000, or ≤1000, or ≤500, or ≤100, or ≤50, or ≤20, or ≤10, or ≤5.0, or ≤2.0 dg/min.

K4] A composition comprising at least the following components:
a) an olefin-based polymer comprising a total unsaturation ≥0.20/1000 C;
b) from 1.0 to 100 ppm of a peroxide, based on the total weight of the composition;
and wherein component a is selected from a telechelic polyolefin of the formula A¹L¹L²A², an unsaturated polyolefin of the formula A¹L¹, or an ethylene/alpha-olefin interpolymer.

L4] The composition of K4] above, wherein the peroxide is present in an amount ≥2.0 ppm, or ≥5.0 ppm , or ≥10 ppm, or ≥12 ppm, or ≥14 ppm, or ≥16 ppm , or ≥18 ppm, based on the weight of the composition, and/or in an amount ≤90 ppm, or ≤80 ppm, or ≤70 ppm, or ≤60 ppm, or ≤50 ppm, or ≤40 ppm, or ≤35 ppm, or ≤30 ppm, or ≤28 ppm, or ≤26 ppm, or ≤24 ppm, or ≤22 ppm, based on the weight of the composition.

M4] The composition of K4] or L4] above, wherein component a has a total unsaturation ≥0.25 /1000 C, or ≥0.30 /1000 C, or ≥0.35 /1000 C, or ≥0.40/1000 C, or ≥0.45 /1000 C, or ≥0.50 /1000 C ≥0.55/1000 C, or ≥0.60 /1000 C, or ≥0.65 /1000 C, and/or a total unsaturation ≤15.0/1000 C, or ≤10.0/1000 C, or ≤5.00/1000 C, or ≤2.00/1000, or ≤1.50/1000 or ≤1.00/1000 C.

N4] The composition of any one of K4]-M4] above, wherein component a is selected from a telechelic polyolefin of the formula A¹L¹L²A², or an unsaturated polyolefin of the formula A¹L¹; and further, the L¹ of the telechelic polyolefin of the formula A¹L¹L²A² is an ethylene/alpha-olefin copolymer structure bonded to A¹ and L², and the L¹ of the unsaturated polyolefin of the formula A¹L¹ is an ethylene/alpha-olefin copolymer structure bonded to A₁; and further, for each ethylene/alpha-olefin copolymer structure, the alpha-olefin is independently selected from the group consisting of propylene, 1-butene, 1-hexene, and 1-octene. Preferably, the L¹ of A¹L¹L²A² is a random interpolymer structure and further a random copolymer structure. Preferably, the L¹ of A¹L¹ is a random interpolymer structure and further a random copolymer structure.

O4] The composition of any one of K4]-N4] above, wherein the composition comprises ≥10.0 wt %, or ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt %, or ≥97.0 wt % of the sum of components a and b, based on the weight of the composition, and/or ≤99.9 wt %, or ≤99.8 wt %, or ≤99.6 wt %, or ≤99.4 wt %, or ≤99.2 wt %, or ≤99.0 wt %, or ≤98.5 wt %, or ≤98.0 wt % of the sum of components a and b, based on the weight of the composition.

P4] A rheology modified composition formed from the composition of any one of K4]-Q4] above.

Q4] The rheology modified composition of any one of B3]-J4] or P4] above, or the process of any one of A]-A3] or M3]-J4] above, wherein the rheology modified composition has a ratio of Melt Strength to melt index (MS/I2) ≥1.8, or ≥1.9, or ≥2.0, or ≥2.1, or ≥2.2 cN·min/dg, where melt strength is measured at 190° C.

R4] The rheology modified composition of any one of B3]-J4], P4] or Q4] above, or the process of any one of A]-A3] of M3]-J4], or Q4] above, wherein the rheology modified composition has a ratio of melt strength to melt index (MS/I2) ≤10, or ≤8.0, or ≤6.0, or ≤4.0 cN·min/dg, where melt strength is measured at 190° C.

S4] An article comprising at least one component formed from the composition of any one of B3]-R4] above.

T4] The article of S4] above, wherein the article is a film, or a foam, and further a film.

U4] The article of S4] above, wherein the article is a solar cell module, a wire or cable, a footwear component, an automotive part, a window profile, a tire, a tube/hose, or a roofing membrane.

V4] A process to form a rheology modified composition, said process comprising thermally treating the composition of any one of K4]-O4] above.

W4] The rheology modified composition of any one of B3]-J4] or P4]-R4] above, or the composition of any one of K4]-O4] above, wherein the composition further comprises at least an additive.

X4] The rheology modified composition of any one of B3]-J4], P4]-R4] or W4] above, or the composition of any one of K4]-O4] or W4] above wherein the composition further comprises a polymer, different from component a in one or more features, such as comonomer type, comonomer content, Mn, Mw, MWD, V0.1, V100 or RR.

### TEST METHODS

### ¹H NMR Method

Sample Preparation: Each sample was prepared by adding approximately 130 mg of sample to 3.25 g of a “50/50 by weight tetrachlorethane-d2/perchloroethylene (TCE-d2/PCE) with 0.001 M Cr(AcAc)₃,” in a NORELL 1001-7, 10 mm, NMR tube. The sample was purged by bubbling N₂ through the solvent, via a pipette inserted into the tube, for approximately five minutes to prevent oxidation. The tube was then capped and sealed with TEFLON tape, before heating and vortex mixing at 115° C. to achieve a homogeneous solution.

Data Acquisition Parameters and Data Analysis: ¹H NMR was performed on a Bruker AVANCE 600 MHz spectrometer, equipped with a Bruker high-temperature CryoProbe, with a sample temperature of 120° C. Two experiments were run to obtain spectra, a control spectrum to quantitate the total polymer protons, and a double presaturation experiment, which suppresses the intense peaks associated with the polymer chains, and enables high sensitivity spectra for quantitation of the end-groups. The control was run with ZG pulse, 16 scans, AQ 1.82 s, D₁ (relaxation delay) 14 s. The double presaturation experiment was run with a modified pulse sequence, 1c1prf2.zz, 64 scans, AQ 1.82 s, D₁ (presaturation time) 2 s, D₁₃ (relaxation delay) 12 s. Unsaturation measurements were made according to the following method. The area under the resonance from the polymer chains (i.e., CH, CH₂, and CH₃ in the polymers) was measured from the spectrum acquired during first experiment (the control spectrum), described above.

The unsaturation was analyzed with the method in Reference 3 noted below. Reference 1: Z. Zhou, R. Kuemmerle, J. C. Stevens, D. Redwine, Y. He, X. Qiu, R. Cong, J. Klosin, N. Montañez, G. Roof, Journal of Magnetic Resonance, 2009, 200, 328. Reference 2: Z. Zhou, R. Kümmerle, X. Qiu, D. Redwine, R. Cong, A. Taha, D. Baugh, B. Winniford, Journal of Magnetic Resonance: 187 (2007) 225. Reference 3: Z. Zhou, R. Cong, Y. He, M. Paradkar, M. Demirors, M. Cheatham, W. deGroot, Macromolecular Symposia, 2012, 312, 88.

The peak areas for each type of observed unsaturation (i.e., vinyl, vinylidene, vinylene, trisubstituted, cyclohexene) was measured from the spectrum acquired during the second (presaturation) experiment described above. Both spectra were normalized to the solvent peak area. Moles of respective unsaturation were calculated by dividing the area under the unsaturation resonance by the number of protons contributing to that resonance. Moles of carbons in the polymers were calculated by dividing the area under the peaks for polymer chains (i.e., CH, CH₂, and CH₃ in the polymers) by two. The amount of total unsaturation (sum of the above unsaturations) was then expressed as a relative ratio of moles of total unsaturation to the moles of carbons in the polymers, with expression of the number of unsaturation per 1000 Carbon (per 1000 C).

### Dynamic Mechanical Spectroscopy (DMS)

The rheology of each composition was analyzed by DMS, using an Advanced Rheometric Expansion System (ARES), equipped with “25 mm stainless steel parallel plates,” under a nitrogen purge. A constant temperature dynamic frequency sweep, in the range of 0.1 to 100 rad/s, was performed under nitrogen, at 190° C. (see Tables 3A and 4A). A sample of approximately “25 mm diameter×3.3 mm thick” was cut from a compression molded plaque (see below). The sample was placed on the lower plate and allowed to equilibrate for five minutes. The plates were then closed to a gap of “2.0 mm,” and the sample trimmed to “25 mm” in diameter. The sample was allowed to equilibrate at 190° C. for five minutes, before starting the test. The complex viscosity was measured at a constant strain amplitude of 10%. The stress response was analyzed in terms of amplitude and phase, from which the storage modulus (G′), loss modulus (G″), dynamic viscosity η*, and tan delta could be calculated. The Viscosities (V0.1, V100) were recorded. Note, V0.1 is the complex viscosity at 0.1 rad/s (190° C.), and V100 is the complex viscosity at 100 rad/s (190° C.).

For each composition, samples were prepared by compression molding approximately 2.3 g material, at 190° C. for five minutes, at 10 MPa pressure, in a “2 in. by 3 in. by 3 mm thick” TEFLON coated chase, and then quenched between chilled platens (15-20° C.) for two minutes.

### Melt Strength

Melt Strength measurements were conducted on a Goettfert Rheotens 71.97 (Goettfert Inc., Rock Hill, S. C.), attached to a Goettfert Rheotester 2000 capillary rheometer. The melted sample (about 25 to 30 grams) was fed with the Goettfert Rheotester 2000 capillary rheometer, equipped with a flat entrance angle (180 degrees) of length of 30 mm, diameter of 2.0 mm, and an aspect ratio (length/diameter) of 15. After equilibrating the sample at 190° C. for 10 minutes, the piston was run at a constant piston speed of 0.265 mm/second. The standard test temperature was 190° C. The sample was drawn uniaxially to a set of accelerating wheels, located 100 mm below the die, with an acceleration of 2.4 mm/s². The force exerted on the wheels was recorded as a function of the take-up speed of the wheels. The following conditions were used in the Melt Strength measurements: plunger speed=0.265 mm/second; wheel acceleration=2.4 mm/s; capillary diameter=2.0 mm; capillary length=30 mm; and barrel diameter=12 mm. Melt Strength was reported as the average plateau force (cN) before the strand broke.

### High Temperature Gel Permeation Chromatography Test—Conventional GPC

The chromatographic system consists of a PolymerChar GPC-IR (Valencia, Spain) high temperature GPC chromatograph, equipped with an internal IR5 infra-red detector (IR5). The autosampler oven compartment is set at 160° Celsius, and the column compartment is set at 150° Celsius. The columns are four AGILENT “Mixed A” 30 cm, 20-micron linear mixed-bed columns. The chromatographic solvent is 1,2,4-trichlorobenzene (TCB), which contained 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° Celsius, with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)): M_{polyethylene}=A×(M_{polystyrene})^{B} (EQ1), where M is the molecular weight, A has a value of 0.4315 and B is equal to 1.0.

A fifth order polynomial is used to fit the respective polyethylene equivalent calibration points. A small adjustment to A (from approximately 0.375 to 0.445) is made to correct for column resolution and band-broadening effects, such that linear homopolymer polyethylene standard is obtained at 120,000 Mw.

The total plate count of the GPC column set is performed with decane (prepared at “0.04 g in 50 milliliters” of TCB, and dissolved for 20 minutes with gentle agitation). The plate count (Equation 2) and symmetry (Equation 3) are measured on a 200 microliter injection according to the following equations:

$$Plate Count = 5.54 * {( \frac{( {RV}_{PeakMax}}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{onetenthheight} - {RV}_{Peakmax} )}{( {RV}_{Peakmax} - Front Peak {RV}_{onetenthheight} )} , \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contained 200 ppm BHT) is added to a pre nitrogen-sparged, septa-capped vial, via the PolymerChar high temperature autosampler. The samples are dissolved for two hours at 160° Celsius under “low speed” shaking.

The calculations of Mn_{(GPC)}, Mw_{(GPC)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( \frac{{IR}_{i}}{{M}_{{polyethylene}_{i}}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , \qquad ( EQ 5 )$$

$$and$$

$${M𝓏}_{( GPC )} = \frac{{\sum }^{i} ( {IR}_{i} * {M}_{{polyethylene}_{i}^{2}} )}{{\sum }^{i} ( {IR}_{i} * {M}_{{poyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated from Equation 7: Flowrate(effective)=Flowrate(nominal)*(RV(FM Calibrated)/RV(FM Sample)) (EQ7). Processing of the flow marker peak is done via the PolymerChar GPCOne™ software. Acceptable flowrate correction is such that the effective flowrate should be within +/−0.7% of the nominal flowrate.

### Melt Index

The melt index I2 (or MI) of an ethylene-based polymer is measured in accordance with ASTM D-1238, condition 190° C./2.16 kg. The melt flow rate MFR of a propylene-based polymer is measured in accordance with ASTM D-1238, condition 230° C./2.16 kg.

### Polymer Density

ASTM D4703 is used to make a polymer plaque for density analysis. ASTM D792, Method B, is used to measure the density of each polymer.

### Mooney Viscosity of Polymer (No oil, no filler)

Mooney Viscosity (ML1+4 at 125° C.) is measured in accordance with ASTM 1646, with a one minute preheat time and a “four minute” rotor operation time. The instrument is an Alpha Technologies Mooney Viscometer 2000. Sample size is around 25 grams.

### Xylene Soluble Fraction

Xylene soluble fraction, or conversely gel content, is measured in accordance with ASTM D2765 Test Method A, with the exception that the samples were not ground into a powder. Samples were in the form of compression molded films, approximately 0.13 mm in thickness, cut into pieces to fit within the stainless steel cloth pouch specified in the method.

### EXPERIMENTAL

### Polymers and Peroxide

A summary of the olefin-based polymers and peroxide used in the studies below is shown in Table 1. Additional properties (for example, GPC, DMS Rheology, ¹H NMR) are shown in Tables 3A, 3B, 4A and 4B.

TABLE 1
Polymers and Peroxide

| | | | | Total |
|---|---|---|---|---|
| | | Density, | MI (or I2) | Unsaturation/1000 C |
| Name | Type | g/cc | dg/min | (¹H NMR) |
| ENGAGE ™ 8200 | Ethylene/1-octene interpolymer | 0.870 | 5.0 | 0.077 |
| ENGAGE ™ 8540 | Ethylene/1-octene interpolymer | 0.909 | 1.0 | 0.103 |
| EO Mono 1 | Ethylene/1-octene unsaturated | 0.872 | 5.1 | 0.441 |
| | polyolefinA¹L¹ - MP4 from | | | |
| | WO2020/140067 | | | |
| EO Tele 1 | Ethylene/1-octene telechelic polyolefin | 0.922 | 1.9 | 0.594 |
| | A¹L¹L²A² - TP8 from 82803 | | | |
| | WO2020/140061 | | | |
| EO Tele 2 | Ethylene/1-octene telechelic polyolefin | 0.872 | 4.7 | 0.731 |
| | A¹L¹L²A² - TP9 from WO2020/140061 | | | |
| TRIGONOX 301 | Peroxide from Nouryon Chemicals B.V. | Not | Not | Not |
| | | Applicable | Applicable | Applicable |

### Polymer Syntheses of EO Mono 1, EO Tele 1 and EO Tele 2

### Catalysts

The (Cat 1) may be prepared according to the teachings of WO 03/40195 and U.S. Pat. No. 6,953,764 B2, and has the following structure:

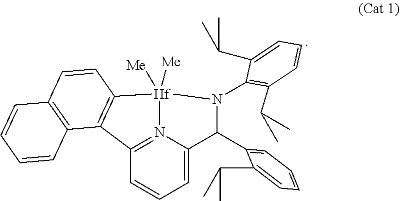

The (Cat 14) may be prepared according to the teachings of WO 2011/102989, and has the following structure:

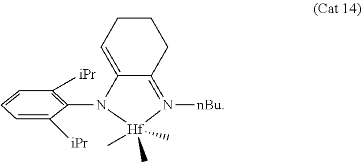

### Preparation of Materials

Unless otherwise noted, all starting reagents and materials were obtained from Sigma-Aldrich. The procatalysts (Cat 1) and (Cat 14) used in the examples below are the same as those discussed above, and prepared according to the methods discussed above in the noted patent references. Procatalyst (Cat 1) may also be identified as [N-(2,6-di(1-methylethyl)-phenyl)amido)(2-isopropylphenyl)(α-naphthalen-2-diyl(6-pyridin-2-diyl)methane)]hafnium dimethyl. “Cocat A” is the co-catalyst used in the examples below, and is bis(hydrogenated tallow alkyl)methyl, tetrakis(pentafluoro-phenyl) borate(1-) amine.

Synthesis of tris(2-(cyclohex-3-en-1-yl)ethyl)aluminum (“CTA 1”).

In a drybox, 4-vinyl-1-cyclohexene (3.2 mL, 24.6 mmol) and triisobutylaluminum (2.0 ml, 7.92 mmol) were added to 5 mL of decane in a vial, equipped with a stir bar and a venting needle on the cap. This mixture was heated to and held at 120° C., with stirring, for 3 hours. After 3 hours, an aliquot sample was dissolved in benzene-d6 for ¹H NMR analysis, and another aliquot was hydrolyzed with water and analyzed by GC/MS. ¹H NMR showed all vinyl groups reacted and the internal double bond remained (Scheme 1). GC/MS showed a clean peak at m/z of 110, consistent to the molecular weight of ethylcyclohexene. Accordingly, ¹H NMR and GC/MS confirmed the synthesis of tris(2-(cyclohex-3-en-1-yl)ethyl)aluminum (“CTA 1”) via non-limiting Scheme 1.

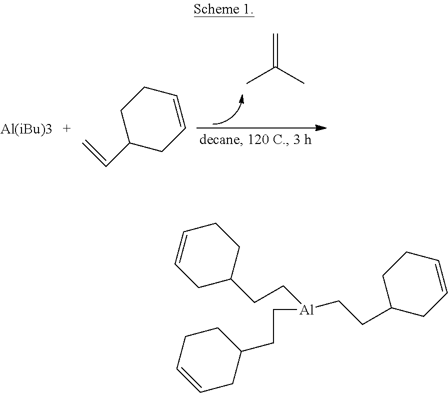

### Continuous Solution Polymerization

Continuous solution polymerizations were carried out in a computer controlled, autoclave reactor, equipped with an internal stirrer. Purified mixed alkanes solvent (ISOPAR E available from ExxonMobil), monomers, and molecular weight regulator (hydrogen or chain transfer agent) were supplied to a 3.8 L reactor, equipped with a jacket for temperature control. The solvent feed to the reactor was measured by a mass-flow controller. A variable speed diaphragm pump controlled the solvent flow rate and pressure to the reactor. At the discharge of the pump, a side stream was taken to provide flush flows for the procatalyst, activator, and chain transfer agent (catalyst component solutions) injection lines. These flows were measured by Micro-Motion mass flow meters and controlled by control valves. The remaining solvent was combined with monomers and hydrogen, and fed to the reactor. The temperature of the solvent/monomer solution was controlled by use of a heat exchanger, before entering the reactor. This stream entered the bottom of the reactor. The catalyst component solutions were metered using pumps and mass flow meters, and were combined with the catalyst flush solvent, and introduced into the bottom of the reactor. The reactor was liquid full at 500 psig with vigorous stirring. Polymer was removed through exit lines at the top of the reactor. All exit lines from the reactor were steam traced and insulated. The product stream was then heated to 230° C., by passing through a post reactor heater (PRH) where beta-H elimination of polymeryl-Al took place. A small amount of isopropyl alcohol was added (at least 1× molar ratio to aluminum) along with any stabilizers or other additives (for example, 50 ppm to 2000 ppm of a primary anti-oxidant), after the PRH, and before devolatilization. Primary anti-oxidants are radical scavengers that are generally organic molecules consisting of hindered phenols or hindered amine derivatives. Examples of primary antioxidants include primary antioxidants that are well known in the polyolefin industry, such as, pentaerythrityl tetrakis-(3-(3,5-di-tert-butyl-4-hydroxyphenol)propionate), which is commercially available from BASF under the name of IRGANOX 1010, or octadecyl-3-(3,5-di-tert-butyl-4-hydroxyphenyl)propionate, which is commercially available from BASF under the name IRGANOX 1076. The polymer product was recovered by extrusion using a devolatilizing extruder.

The polymerization conditions and results prior to the post reactor heating (PRH) are shown in Table 2. Additional abbreviations in Table 2 were as follows: “Co.” stands for comonomer; “sccm” stands for standard cm³/min; “T” refers to temperature; “Cat” stands for Procatalyst; “Cat 1” stands for Procatalyst (Cat 1); “Cat 14” stands for Procatalyst (Cat 14), “Cocat” stands for Cocat A; “A1 CTA” stands for aluminum chain transfer agent”; “TEA” stands for triethylaluminum; “Poly Rate” stands for polymer production rate; “Conv” stands for percent ethylene conversion in reactor; and “Eff.” stands for efficiency, kg polymer/g catalyst metal.

TABLE 2
Polymerization Conditions

| Parameter | Units | EO Mono 1 | EO Tele 1 | EO Tele 2 |
|---|---|---|---|---|
| C2 | lbs/hr | 2.78 | 3.84 | 2.78 |
| Co. Type | | Octene | Octene | Octene |
| Co. | lbs/hr | 2.41 | 1.07 | 2.67 |
| Solv. | lbs/hr | 30.44 | 42.19 | 29.52 |
| H2 | sccm | 0 | 0 | 0 |
| T | ° C. | 115 | 125 | 115 |
| Cat | | Cat 1 | Cat 14 | Cat 1 |
| Cat. Conc. | ppm Hf | 63.2 | 54.2 | 63.2 |
| Cat. Flow | lbs/hr | 0.385 | 0.149 | 0.372 |
| CTA | | TEA | CTA 1 | CTA 1 |
| CTA Conc. | ppm Al | 1920 | 1478 | 3994 |
| CTA Flow | lbs/hr | 0.723 | 0.210 | 0.241 |
| Cocat A | ppm | 894 | 495 | 894 |
| Cocat A Flow | lbs/hr | 0.219 | 0.131 | 0.212 |
| Poly Rate | lbs/hr | 3.72 | 3.5 | 2.7 |
| Conv | % | 97.6 | 89.8 | 96.4 |
| Solids | % | 8.4 | 7.5 | 8.3 |
| Eff. | | 0.114 | 0.431 | 0.114 |

### Rheology Modification via E-Beam

All e-beamed samples were produced by irradiating the polymer composition, in pellet form, in a continuous process. A DYNAMITRON Linear Electron Beam accelerator was used. The operating parameters of the electron-beam accelerator were as follows: dosage of 1 MRad, an energy range of 4.5 MeV, a beam power, over the whole energy range, of 150 kW, a beam energy spread of +/−10 percent and an average current of 30 milliamps (mA). The velocity of the bed of pellets at a particular dosage rate was determined depending on the dosage. The depth of the bed of pellets was between 1 to 1.5 inches to ensure dosage uniformity.

Resins were then evaluated by GPC, DMS rheology, and ¹H NMR. In each case, the untreated resin was also evaluated. The properties and property changes relative to the untreated resins are shown in Tables 3A and 3B. Three resins of similar density and 12 (approx. 0.870 g/cc, approx. 5 dg/min), but different unsaturation content were evaluated. ENGAGE™ 8200 is the comparative control. In each case (Comp. A vs. Control A; Inv. 1 vs. Control 1; and Inv. 2 vs. Control 2), the e-beaming resulted in an increase in Mw, Mz, V0.1, and RR of the resins, with minimal change in Mn and V100. However, for the inventive examples (Inv. 1 and Inv. 2), the percent increases in V0.1, and RR are significantly higher than those changes for the comparative example (Comp. A), indicating a higher degree of shear thinning rheology for the inventive examples. The e-beamed samples all had xylene soluble fractions of 99.8 wt % or higher (gel content of 0.2 wt % or less), indicating the samples were rheology-modified and not cross-linked.

Note, for Table 3A, the change in a particular property (ΔF) is determined as follows: ΔF={[F(“1 Mrad” resin)−F(“0 Mrad” resin)]/F(“0 Mrad” resin)}×100, where F is the property of interest, such as, Mn, Mw, Mz, MWD, V0.1, V100, RR, Tanδ at 0.1 rad/s (190° C.) and Tanδ at 100 rad/s (190° C.).

### Rheology Modification via Peroxide

Each polymer resin was blended, using a Thermo Micro-18 Twin Screw Extruder, with 2 wt % of a peroxide masterbatch (1000 ppm TRIGONOX 301 in Dow LDPE 4016, resulting in 20 ppm TRIGONOX 301 in the final blend). DMS Rheology, Melt Strength and ¹H NMR were measured (results shown in Tables 4A and 4B). Similar to the previous dataset, the relative increase in each of the low shear viscosity (V0.1), the rheology ratio (RR), and the Melt Strength is higher for the inventive example (Inv. 3) than the comparative example (Comp. B). Inventive 3 had a higher degree of shear thinning and a greater increase in Melt Strength than Comparative B. Also, Inventive 3 had a Melt Strength of 5.4 cN at an I2 value of 1.3 dg/min, while Comparative B reached a similar Melt Strength of 5.3 cN at a significantly lower 12 (higher MW) of 0.8 dg/min. Note, it was discovered, that although the comparative compositions contained lower amounts of the same primary anti-oxidant, as compared to the inventive compositions, and thus less potential for radical scavenging by the anti-oxidant, the comparative examples were not effectively rheology modified, and had smaller changes in rheology parameters, as compared to the inventive compositions.

Note, for Table 4A, the change in a particular property (ΔF) is determined as follows:

ΔF={[F(“Peroxide” resin)−F(“No Peroxide” resin)]/F(“No Peroxide” resin)}×100,

where F is the property of interest, such as, V0.1, V100, RR, Tanδ at 0.1 rad/s (190° C.) and Tanδ at 100 rad/s (190° C.).

For Table 4B, the change in a particular property (ΔF) is determined as follows: ΔF={[F(“Peroxide”)−F(“No Peroxide” resin)]/F(“No Peroxide” resin)}×100, where F is the property of interest, such as, I2 and Melt Strength.

TABLE 3A
Rheology Modified Compositions (e-beam)

| | | Example | | | | | |
|---|---|---|---|---|---|---|---|
| | | Control | Comp. | Control | Inv. | Control | Inv. |
| | | A | A | 1 | 1 | 2 | 2 |
| | | Resin | | | | | |
| | | ENGAGE ™ | ENGAGE ™ | EO | EO | EO Tele | EO |
| | | 8200 | 8200 | Mono 1 | Mono 1 | 2 | Tele 2 |
| | E-beam Dose, | 0 | 1 | 0 | 1 | 0 | 1 |
| | MRad | | | | | | |
| GPC | Mn, g/mol | 35,836 | 35,340 | 32,689 | 31,943 | 32,968 | 32,522 |
| | Mw, g/mol | 75,486 | 84,898 | 79,030 | 90,245 | 82,260 | 99,914 |
| | Mz, g/mol | 130,583 | 172,223 | 157,436 | 205,711 | 175,471 | 253,221 |
| | MWD = | 2.11 | 2.40 | 2.42 | 2.83 | 2.50 | 3.07 |
| | Mw/Mn | | | | | | |
| | ΔMn, % | — | −1% | — | −2% | — | −1% |
| | ΔMw, % | — | 12% | — | 14% | — | 21% |
| | ΔMz, % | — | 32% | — | 31% | — | 44% |
| | ΔMWD, % | — | 14% | — | 17% | — | 23% |
| DMS- | V0.1, Pa-s | 1,607 | 4,927 | 1,513 | 5,555 | 1,735 | 7,692 |
| 190° C. | V100, Pa-s | 721 | 809 | 725 | 875 | 784 | 980 |
| | RR = V0.1/V100 | 2.23 | 6.09 | 2.09 | 6.35 | 2.21 | 7.85 |
| | Tanδ at 0.1 rad/s | 77.1 | 7.1 | 53.1 | 5.3 | 42.8 | 4.0 |
| | (190° C.) | | | | | | |
| | Tanδ at 100 rad/s | 1.6 | 1.2 | 1.7 | 1.2 | 1.6 | 1.1 |
| | (190° C.) | | | | | | |
| | ΔV0.1, % | 0% | 207% | 0% | 267% | 0% | 343% |
| | ΔV100, % | 0% | 12% | 0% | 21% | 0% | 25% |
| | ΔRR, % | 0% | 173% | 0% | 205% | 0% | 254% |
| | Δ Tanδ at 0.1 rad/s, % | 0% | −91% | 0% | −90% | 0% | −91% |
| | Δ Tanδ at 100 rad/s, % | 0% | −25% | 0% | −29% | 0% | −31% |
| | Xylesolne soluble | — | 99.8% | — | 99.8% | — | 99.9% |
| | content, wt % | | | | | | |

TABLE 3B
Rheology Modified Compositions (e-beam)

| | | Example | | | | | |
|---|---|---|---|---|---|---|---|
| | | Control | Comp. | Control | | Control | |
| | | A | A | 1 | Inv. 1 | 2 | Inv. 2 |
| | | Resin | | | | | |
| | | ENGAGE ™ | ENGAGE ™ | EO | EO | EO Tele | EO Tele |
| | | 8200 | 8200 | Mono 1 | Mono 1 | 2 | 2 |
| | Ebeam Dose, | 0 | 1 | 0 | 1 | 0 | 1 |
| | MRad | | | | | | |
| ¹H NMR | Vinyl | 0.047 | 0.036 | 0.291 | 0.263 | 0.307 | 0.290 |
| Unsaturation | Vinylidene | 0.012 | 0.006 | 0.126 | 0.108 | 0.107 | 0.097 |
| unit/ | Vinylene | 0.011 | 0.069 | 0.018 | 0.062 | 0.018 | 0.058 |
| 1,000 carbon | Trisubstituted | 0.007 | 0.023 | 0.006 | 0.026 | 0.003 | 0.024 |
| | Cyclohexene | 0 | 0 | 0 | 0 | 0.296 | 0.280 |
| | Total Unsat. | 0.077 | 0.134 | 0.441 | 0.459 | 0.731 | 0.749 |
| | % Vinyl | 61.0 | 26.9 | 66.0 | 57.3 | 42.0 | 38.7 |
| | % Vinylidene | 15.6 | 4.5 | 28.6 | 23.5 | 14.6 | 13.0 |
| | % Vinylene | 14.3 | 51.5 | 4.1 | 13.5 | 2.3 | 7.7 |
| | % Trisubstituted | 9.1 | 17.2 | 1.4 | 5.7 | 0.4 | 3.2 |
| | % Cyclohexene | | | | | 40.5 | 37.4 |

TABLE 4A
Rheology Modified Compositions (Peroxide)

| | | Example | | | |
|---|---|---|---|---|---|
| | | Control B | Comp. B | Control 3 | Inv. 3 |
| | | Resin | | | |
| | | ENGAGE ™ | ENGAGE ™ | EO | EO |
| | | 8540 | 8540 | Tele 2 | Tele 2 |
| | TRIGONOX 301 ppm | 0 | 20 | 0 | 20 |
| DMS- | V0.1, Pa-s | 13,472 | 17,943 | 5,412 | 10,578 |
| 190° C. | V100, Pa-s | 1,380 | 1,393 | 1,326 | 1,432 |
| | RR = V0.1/V100 | 9.8 | 12.9 | 4.1 | 7.4 |
| | Tanδ at 0.1 rad/s (190° C.) | 3.9 | 3.0 | 5.8 | 3.0 |
| | Tanδ at 100 rad/s (190° C.) | 1.1 | 1.0 | 1.5 | 1.3 |
| | ΔV0.1, % | 0% | 33% | 0% | 95% |
| | ΔV100, % | 0% | 1% | 0% | 8% |
| | ΔRR, % | 0% | 32% | 0% | 81% |
| | ΔTanδ 0.1, % | 0% | −23% | 0% | −48% |
| | ΔTanδ 100, % | 0% | −9% | 0% | −13% |

TABLE 4B
Rheology Modified Compositions (Peroxide)

| | | Example | | | |
|---|---|---|---|---|---|
| | | Control B | Comp. B | Control 3 | Inv. 3 |
| | | Resin | | | |
| | | ENGAGE ™ | ENGAGE ™ | EO | EO |
| | | 8540 | 8540 | Tele 2 | Tele 2 |
| | TRIGONOX 301 ppm | 0 | 20 | 0 | 20 |
| Rheotens, | Melt Strength, cN | 4.1 | 5.3 | 2.4 | 5.4 |
| 190° C. | ΔMelt Strength, % | 0% | 29% | 0% | 125% |
| MFR, 190° C., | I2, dg/min | 0.9 | 0.8 | 2.0 | 1.3 |
| 2.16 kg | ΔI2, % | 0% | −15% | 0% | −37% |
| ¹H NMR | Vinyl | — | — | 0.283 | — |
| Unsaturation | Vinylidene | — | — | 0.021 | — |
| unit/1,000 | Vinylene | — | — | 0.012 | — |
| carbon | Trisubstituted | — | — | 0 | — |
| | Cyclohexene | — | — | 0.278 | — |
| | Total | — | — | 0.594 | — |
| | % Vinyl | — | — | 47.6 | — |
| | % Vinylidene | — | — | 3.5 | — |
| | % Vinylene | — | — | 2.0 | — |
| | % Trisubstituted | — | — | 0 | — |
| | % Cyclohexene | — | — | 46.8 | — |

1. A process to form a rheology modified composition, the process comprising applying radiation, and optionally heat, to a composition that comprises at least the following component:
a) an olefin-based polymer comprising a total unsaturation ≥0.20/1000 C; and wherein the radiation is applied using an electron beam (e-beam) at a dosage selected from 0.1 MRad to 1.5 MRad; and wherein component a is selected from a telechelic polyolefin of the formula A¹L¹L²A², an unsaturated polyolefin of the formula A¹L¹, or an ethylene/alpha-olefin interpolymer.

2. A process to form a rheology modified composition, the process comprising applying heat, and optionally radiation, to a composition that comprises at least the following components:
a) an olefin-based polymer comprising a total unsaturation ≥0.20/1000 C;
b) from 1.0 to 100 ppm of a peroxide, based on the weight of the composition; and
wherein component a is selected from a telechelic polyolefin of the formula A¹L¹L²A², an unsaturated polyolefin of the formula A¹L¹, or an ethylene/alpha-olefin interpolymer.

3. The process of claim 1, wherein component a has a density from 0.854 to 0.930 g/cc.

4. The process of any one of claim 1, wherein component a is an ethylene-based polymer.

5. The process of claim 1, wherein component a is a telechelic polyolefin of the formula A¹L¹L²A², or an unsaturated polyolefin of the formula A¹L¹.

6. The process of claim 5, wherein the L¹ of the telechelic polyolefin of the formula A¹L¹L²A² is an ethylene/alpha-olefin copolymer structure bonded to A¹ and L², and the L¹ of the unsaturated polyolefin of the formula A¹L¹ is an ethylene/alpha-olefin copolymer structure bonded to A¹.

7. The process of claim 6, wherein for each ethylene/alpha-olefin copolymer structure, the alpha-olefin is independently selected from the group consisting of propylene, 1-butene, 1-hexene, and 1-octene.

8. The process of claim wherein component a has a rheology ratio (RR=V0.1/V100, each at 190° C.) from 1.0 to 20.

9. A rheology modified composition formed from the process of claim 1.

10. The rheology modified composition of claim 9, wherein the rheology modified composition has a V0.1 (at 190° C.) from 100 Pa·s to 100,000 Pa·s.

11. The rheology modified composition of claim 9, wherein the rheology modified composition has a rheology ratio (RR=V0.1/V100, each at 190° C.) from 1.1 to 100.

12. The rheology modified composition of claim 9, wherein the rheology modified composition meets the following relationship: ΔV0.1 ≥50%; and where ΔV0.1=[(V0.1_{(RM Composition)}−V0.1_{(Composition)})/(V0.1_{(Composition)})]×100], where “RM Composition” is the rheology modified composition and “Composition” is the composition before rheology modification, and V0.1 is the complex viscosity at 0.1 rad/s, in units of Pa·s, measured at 190° C.

13. The rheology modified composition of claim 9, wherein the rheology modified composition meets the following relationship: ΔRR ≥50%;
and where ΔRR=[(RR_{(RM composition)}−RR_{(Composition)})/(RR_{(Composition)})]×100], where “RM Composition” is the rheology modified composition and “Composition” is the composition before rheology modification, and RR=V0.1/V100, and V0.1 and V100 are each measured at 190° C.

14. The rheology modified composition of claim 9, wherein the rheology modified composition has an MWD from 2.00 to 4.00.

15. An article comprising at least one component formed from the composition of claim 9.
